(19) United States
(12) Patent Application Publication
(10) Pub. No.: US 2006/0267785 A1
(43) Pub. Date: Nov. 30, 2006

(54) Liquid level sensor

(76) Inventors: Robert C. Viscosi, Lancaster, PA (US); Shawn P. Doyle, New Philadelphia, PA (US); Timofey Sitnikov, Lititz, PA (US)

Correspondence Address: BARLEY SNYDER, LLC, 1000 WESTLAKES DRIVE, SUITE 275, BERWYN, PA, 19312, US

(21) Appl. No.: 11/350,342

(22) Filed: Feb. 8, 2006

Related U.S. Application Data
(60) Provisional application No. 60/651,167, filed on Feb. 9, 2005.

(51) Int. Cl. G08B 21/00

(52) U.S. Cl. 340/623

(57) ABSTRACT

Disclosed is an embodiment of an improved liquid level sensor having a housing, a circuit including, for example, a circuit board, pins connected to the circuit and an electrical connector being integrally formed on the cover. The housing has a main portion and a cover defining a cavity therebetween. A circuit board is positioned in the cavity. A plurality of pins are electrically connected to the circuit board and extend through the main portion. The electrical connector is integrally formed on an outer surface of the cover such that its contacts are electrically connected to the circuit board. Additionally, conductive tubes extend from the housing and are electrically connected to the circuit.

### FIELD OF THE INVENTION

The invention relates to a liquid level sensor.

### BACKGROUND OF THE INVENTION

Liquid level sensors are used in a variety of applications to sense fluid levels in reservoirs where it is important or desirable to periodically or continuously measure the level of fluid within the reservoir.

Prior art sensors include conventional fuel sensors which include a float carried on the end of a long pivoting arm suspended within the interior of a reservoir such as a fuel supply tank. As the arm pivots, a short wiper blade having a ball contact slideably engages wires on a wound wire rheostat that varies in resistance in accordance with the position of the float and hence liquid level. The angular position of the pivoting float arm, or more particularly the incremental angle of the arm, is not directly proportional to the vertical incremental change in float position and hence not directly proportional to liquid levels. An improvement in this type of mechanism is disclosed in U.S. Pat. No. 4,920,798 issued to Weaver. This reference teaches a fuel level sender which has a vertically reciprocal foam float that carries a slideable dual dwell contact member biased by springs in the float toward a fixed film resistor plate.

Another form of liquid level sensor employs a capacitive probe having a pair of continuous elongated elements positioned on a substrate of the probe. This form of sensing system makes use of the difference in the dielectric of air from various liquids. In such systems, some means is provided for generating a signal which is applied to one plate of the probe. The overall capacitance of the capacitor formed by the two plates, and thus the magnitude of the signal coupled onto the other one of the plates on the probe, will change as the percentage of the probe submerged in a fluid changes. Thus, the magnitude of the signal coupled onto the output plate of the probe can provide a relative indication of the area of the probe which is submerged in fluid and/or exposed in air. An example of this type of sensor is shown in U.S. Pat. No. 5,477,727 issued to Koga.

### SUMMARY

The invention provides an improved liquid level sensor having a housing, a circuit including for example a circuit board, pins connected to the circuit and an electrical connector being integrally formed on the cover. The housing has a main portion and a cover defining a cavity therebetween. A circuit board is positioned in the cavity. A plurality of pins are electrically connected to the circuit board and extend through the main portion. The electrical connector is integrally formed on an outer surface of the cover such that its contacts are electrically connected to the circuit board. Additionally, conductive tubes extend from the housing and are electrically connected to the circuit.

### BRIEF DESCRIPTION OF THE DRAWINGS

FIG. 1 is a perspective view of the liquid level sensor of the present invention and includes partial enlarged detail sections 1A and 1B which are shown in FIGS. 1A and 1B respectively.

FIG. 2 is a cross-sectional view of the sensor of FIG. 1 including partial enlarged detail sections 2A and 2B which are shown in FIGS. 2A and 2B respectively.

### DETAILED DESCRIPTION OF THE EMBODIMENT

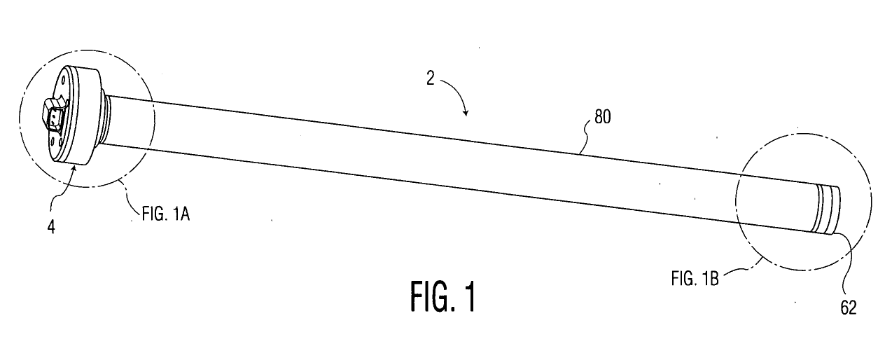

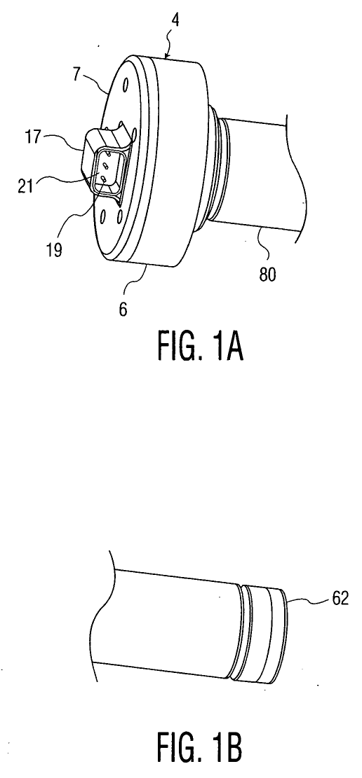

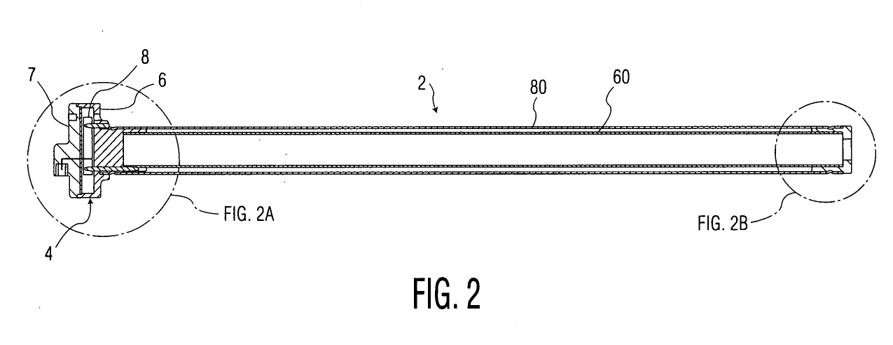

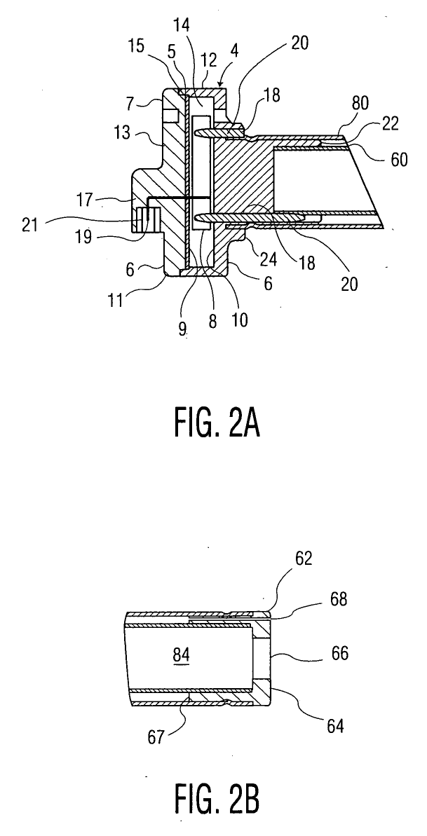

Referring to FIGS. 1, 1A and 1B a liquid level sensor 2 is shown. The sensor 2 has a housing 4 which receives a printed circuit board 8 (FIGS. 2, 2A, 2B) therein, first and second tubes 60, 80 and an end cap 62. In the embodiment shown, the housing 4 has a circular configuration when viewed from the top. However, other configurations of the housing are possible without departing from the scope of the invention.

Beginning with the housing 4 each of the major components will be described in greater detail. Referring to FIGS. 2, 2A and 2B, the housing 4, being formed of an insulative material, has a main portion 6 which houses the printed circuit board 8 therein and a cover 7. The main portion 6 has a bottom wall 10 and a circumferentially extending side wall 12. The side wall 12 has a circumferential flange 5 around a distal end. The bottom wall 10, side wall 12 and the cover 7 define a cavity 14 into which the circuit board 8 is positioned. Various circuit board locating features and circuit board support features may be provided on the bottom wall 10, side wall 12, cover 7 or anywhere within the cavity 14. Pin-receiving openings 18 extend from the cavity 14 through the bottom wall 10. With the circuit board 8 properly positioned in the cavity 14, corresponding pin-receiving openings or socket connectors on the circuit board 8 align with the pin-receiving openings 18. Circuit pads or traces may be provided on the circuit board 8 proximate the corresponding pin-receiving openings or sockets to form a circuit between the pins 20 and the electrical connector 50. Conductive pins 20 are inserted into the openings 18 from the cavity 14. The pins 20 are frictionally received or otherwise secured in openings 18. The pins 20 are positioned in openings 18 such that they are in electrical engagement with respective sides of first and second tubes 60, 80. One or more first tube positioning features 22 extend outwardly from the bottom wall 10 in a direction opposite the cavity 14. One or more second tube positioning features 24 extend similarly from the bottom wall 10 and generally in parallel with the first tube positioning features 22.

The cover 7 has an inner wall 9, a circumferential side wall 11 extending from the inner wall 9 and an outer surface 13 extending from the circumferential side wall 11. Along the outer surface 13, an integral electrical connector housing 17 is formed. A plurality of contacts 19 are located within the connector housing 17 and extend from a mating connector receiving opening 21 through the inner wall 9 and into the cavity 14 to mate with the circuit board 8. A complementary flange 15 is formed along the inner wall 9 and circumferential side wall 11. The complementary flange 15 is profiled to mate with the flange 5 of the main portion 6. The cover 7 is secured to the main portion 6 along the flange 5 and complementary flange 15 by an ultrasonic weld, and adhesive or other suitable securing means. The contacts 19 of the electrical connector 17 are electrically connected to the circuit board 8 by use of through hole connections, a socket connector mounted on the circuit board 8, or other suitable electrical interface.

Once the circuit board 8 is properly positioned in the cavity 14, the cavity 14 may be optionally filled with a potting material. Alternatively, it is possible to provide a sealing gel or the like in the cavity 14.

First tube 60 being formed of a conductive material is secured to the bottom wall 10 proximate the first positioning feature 22 as shown in FIG. 2A. The length of the first tube 60 will vary depending upon the application. Second tube 80 is secured to the bottom wall 10 proximate the second positioning feature 24 in the same direction as first tube 60. The first and second tubes 60, 80 are further secured to the main portion 6 by application of a crimp as shown in detail of FIG. 2A. The length of the second tube 80 will also vary according to the application. However, the length of the first tube 60 and second tube 80 will be approximately the same for respective applications. The first and second tubes 60, 80 have a generally circular cross-section. The center of tube 80 is hollow as indicated by 84 to allow the first tube 60 to be housed therein. The second or outer tube 80 encompasses the first or inner tube 60 to form a coaxial arrangement. The spacing between the tubes 60,80 is maintained by the end cap 62 as shown in FIG. 2B. The end cap 62 also cooperates with the outer tubes 60, 80 to provide rigidity and strength to the tubes 60, 80. The spacing and configuration of the tubes 60, 80 form a capacitive circuit.

The end cap 62 is formed of an insulated material and features a main wall 64 having a central opening 66 formed therein. A tube alignment projection 67 extends from the main wall 64. At least one minor opening 68 is formed in the tube alignment projection 67. In assembly, the first tube 60 is secured on an inner surface of the tube alignment projection 67 and the second tube 80 is secured along an outer surface of the tube alignment projection 67. A crimp is applied as shown in FIG. 2B for securing these components to each other. Other suitable securing means may be employed.

In operation, the opening 66 allows fluid to be sensed by the sensor 2 to pass within the first tube 60. Likewise, the minor opening 68 allows fluid to pass in the space formed between the first and second tube 60, 80. Since the tubes 60, 80 form an electrical equivalent of a parallel plate capacitor, as fluid fills into the tubes 60, 80 the capacitance changes and is sensed by circuitry on the circuit board 8 to indicate the fluid level.

The circuitry on the circuit board 8 includes a relaxation oscillator, a controller, an optional temperature compensation circuit, a power supply, and modulated (ie. pulse width modulated PWM) output.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A liquid level sensor comprising:
a housing having circuitry provided therein,
a conductive inner tube extending from the housing,
a conductive outer tube extending from the housing, the inner tube being positioned within a hollow center of the outer tube to form a coaxial configuration,
the circuitry, outer tube, and inner tube forming a capacitive circuit to measure a liquid level.

2. The liquid level sensor of claim 1 wherein the housing further comprises a main portion and a cover defining a cavity.

3. The liquid level sensor of claim 2 wherein the main portion has a bottom wall and a side wall extending circumferentially from the bottom wall.

4. The liquid level sensor of claim 3 wherein conductive pins pass through the bottom wall and electrically couple the inner and outer tubes to the circuitry.

5. The liquid level sensor of claim 2 further comprising an electrical connector housing being integrally formed in the cover.

6. The liquid level sensor of claim 5 wherein contacts in the electrical connector housing are electrically connected to the circuitry through the cover.

7. The liquid level sensor of claim 6 wherein the cover is secured to the main portion along flanges formed in the main portion and cover.

8. The liquid level sensor of claim 7 wherein the cover is secured to the main portion by an ultrasonic weld.

9. The liquid level sensor of claim 4 further comprising tube positioning features extending outward from the bottom wall for engaging the inner and outer tubes.

10. The liquid level sensor of claim 9 wherein the inner and outer tubes are secured by a crimp located in the vicinity of the positioning features.

11. The liquid level sensor of claim 9 further comprising an end cap located on a distal end of the inner and outer tubes.

12. The liquid level sensor of claim 11 wherein the end cap has a main wall with a central opening formed therein to allow fluid to pass inside the inner tube from the distal end.

13. The liquid level sensor of claim 12 wherein the end cap further comprises an alignment projection extending from the main wall to a location between the inner and outer tubes.

14. The liquid level sensor of claim 13 further comprising a minor opening formed in the alignment projection allowing passage of fluid from the distal end into an area between the inner and outer tubes.

15. The liquid level sensor of claim 14 wherein the end cap is secured to the inner and outer tubes by a crimp.

16. A liquid level sensor comprising:
a housing having a main portion and a cover defining a cavity therebetween;
a circuit board being positioned in the cavity;
a plurality of pins being electrically connected to the circuit board and extending through the main portion; and
tubes extending outward from the main portion to form a capacitance therebetween and being electrically connected to the pins.

17. The liquid level sensor of claim 16 further comprising an electrical connector housing being integrally formed in the cover.

18. The liquid level sensor of claim 17 wherein contacts in the electrical connector housing are electrically connected to the circuit board through the cover.

19. The liquid level sensor of claim 18 wherein the cover is secured to the main portion along flanges formed in the main portion and cover.

20. The liquid level sensor of claim 19 wherein the cover is secured to the main portion by an ultrasonic weld.

21. The liquid level sensor of claim 20 further comprising tube positioning features extending outward from the main portion for engaging the tubes.

22. The liquid level sensor of claim 21 wherein the tubes are secured by a crimp located in the vicinity of the positioning features.

23. The liquid level sensor of claim 22 further comprising an end cap located on a distal end of the tubes.

24. The liquid level sensor of claim 23 wherein the end cap has a main wall with a central opening formed therein.

25. The liquid level sensor of claim 24 wherein the end cap further comprises an alignment projection extending from the main wall to a location between the tubes.

26. The liquid level sensor of claim 25 further comprising a minor opening formed in the alignment projection allowing passage of fluid from the distal end into an area between the tubes.

27. The liquid level sensor of claim 26 wherein the end cap is secured to the inner and outer tubes by a crimp.

28. A liquid level sensor comprising:
a housing having a main portion and a cover defining a cavity therebetween;
a circuit board being positioned in the cavity;
a plurality of pins being electrically connected to the circuit board and extending through the main portion; and
an electrical connector housing being integrally formed on an outer surface of the cover having contacts which are electrically connected the circuit board.

29. The liquid level sensor of claim 28 further comprising conductive tubes extending outward from the main portion to form a capacitance therebetween and being electrically connected to the pins.

30. The liquid level sensor of claim 29 wherein the cover is secured to the main portion along flanges formed in the main portion and cover.

31. The liquid level sensor of claim 30 wherein the cover is secured to the main portion by an ultrasonic weld.

32. The liquid level sensor of claim 29 further comprising tube positioning features extending outward from the main portion for engaging the tubes.

33. The liquid level sensor of claim 32 wherein the tubes are secured by a crimp located in the vicinity of the positioning features.

34. The liquid level sensor of claim 33 further comprising an end cap located on a distal end of the tubes.

35. The liquid level sensor of claim 34 wherein the end cap has a main wall with a central opening formed therein.

36. The liquid level sensor of claim 35 wherein the end cap further comprises an alignment projection extending from the main wall to a location between the tubes.

37. The liquid level sensor of claim 36 further comprising a minor opening formed in the alignment projection allowing passage of fluid from the distal end into an area between the tubes.

38. The liquid level sensor of claim 26 wherein the end cap is secured to the inner and outer tubes by a crimp.
